(19) United States
(12) Patent Application Publication
(10) Pub. No.: US 2020/0388868 A1
(43) Pub. Date: Dec. 10, 2020

(54) OPEN TYPE MODULE STRUCTURE OF FUEL CELL POWER PACK

(71) Applicant: DOOSAN MOBILITY INNOVATION INC., Yongin-si (KR)

(72) Inventors: Gyujung SHIM, Yongin-si (KR); Jaehwan LEE, Suwon-si (KR); Kibeom KIM, Suwon-si (KR)

(21) Appl. No.: 16/881,538

(22) Filed: May 22, 2020

Related U.S. Application Data
(60) Provisional application No. 62/857,319, filed on Jun. 5, 2019.

(30) Foreign Application Priority Data
Jun. 19, 2019 (KR) 10-2019-0073081

(51) Int. Cl. H01M 8/04746; H01M 8/02

(52) U.S. Cl. CPC H01M 8/04753; H01M 2250/20; H01M 8/02

(57) ABSTRACT

An open type module structure of a fuel cell power pack is provided. The open type module structure of a fuel cell power pack may include a body frame, a fuel tank accommodating part disposed on a central portion of the body frame to accommodate a fuel tank, stack accommodating parts disposed at both sides of the body frame to accommodate a stack of fuel cells, a control panel disposed at a bottom of a front portion of the body frame, a valve detachable part disposed on the front portion of the body frame and configured to be connected to a regulator valve of the fuel tank, and a manifold part disposed on the front portion of the body frame to connect the valve detachable part with the stack of fuel cells.

### CROSS-REFERENCE TO RELATED APPLICATIONS

This application claims priority to U.S. Provisional Patent Application No. 62/857,319 filed on Jun. 5, 2019 in the U.S. Patent and Trademark Office, and Korean Patent Application No. 10-2019-0073081, filed on Jun. 19, 2019 in the Korean Intellectual Property Office, the disclosures of which are incorporated herein by reference in their entireties.

### BACKGROUND

### Field

Apparatuses and methods consistent with exemplary embodiments relate to an open type module structure of a fuel cell power pack, and more particularly, to an open type module structure of a fuel cell power pack which may configure a module structure of a fuel cell power pack in an open type to increase light weight and visibility, thereby improving fuel efficiency, increasing a flight time, and simplifying maintenance.

### Description of the Related Art

A drone is a generic term of unmanned aerial vehicles. The drone, which is usually controlled by a radio wave, was initially used for military to practice the intercepting of air forces, anti-aircraft guns, or missiles.

As a wireless technology gradually develops, the drone is used not only for merely practicing the intercepting but also for destroying target facilities with a military reconnaissance aircraft and various weapons mounted thereto.

In recent years, the utilization of the drone has increased. A small drone is developed and used for a leisure purpose, and a popularity of the drone is gradually increasing to a point of the drone maneuvering competition being held. Further, a delivery industry also plans and executes a delivery mechanism which transports ordered goods by using the drone.

In line with such a trend, major companies around the world regard a drone-related industry as a promising new business and are focusing on investment activities and technology development.

In an operation of the drone, one of the most important things is whether a long-time operation is possible. Most drones currently used do not have a long flight time. The drone is required to be operated by driving a plurality of propellers, and a lot of power is consumed to drive the propellers.

However, if a bulky high-capacity battery or a large number of batteries is or are mounted to the drone in order to increase the flight time, a size and weight of the drone may increase due to a size and weight of the battery, thereby leading to inefficient results. Particularly, for a delivery-related drone, a payload value is required to be considered, such that a reduction in the size and weight of the drone itself becomes one of the most important factors in the operation of the drone, and thus there is a limit to increase the capacity of a general battery in the market for the long-time operation.

Further, if the bulky high-capacity battery or a large number of batteries is or are indiscriminately mounted to the drone, an operation ability of the drone may be degraded.

Recently, a fuel cell power pack using hydrogen gas which is detached from the drone is being studied to solve the above described problems. However, even if the fuel cell power pack is mounted to the drone, the weight of the fuel cell power pack needs to be reduced in order to reduce an overall weight of the drone.

### SUMMARY

Aspects of one or more exemplary embodiments provide an open type module structure of a fuel cell power pack, which may configure a module structure of a fuel cell power pack in an open type to increase light weight and visibility, thereby improving fuel efficiency, increasing a flight time, and simplifying maintenance.

Additional aspects will be set forth in part in the description which follows and, in part, will become apparent from the description, or may be learned by practice of the exemplary embodiments.

According to an aspect of an exemplary embodiment, there is provided an open type module structure of a fuel cell power pack including: a body frame; a fuel tank accommodating part disposed on a central portion of the body frame to accommodate a fuel tank; stack accommodating parts disposed at both sides of the body frame to accommodate a stack of fuel cells; a control panel disposed at a bottom of a front portion of the body frame; a valve detachable part disposed on the front portion of the body frame and configured to be connected to a regulator valve of the fuel tank; and a manifold part disposed on the front portion of the body frame to connect the valve detachable part with the stack of fuel cells.

The fuel tank accommodating part may include: a first support block disposed on a rear portion of the body frame and configured to include an upper portion formed to have a curved shape to support a bottom of the fuel tank; and a second support block disposed on a bottom of the body frame and configured to include an upper portion formed to have a curved shape to support the bottom of the fuel tank.

The open type module structure of the fuel cell power pack may further include a plurality of auxiliary beams disposed at both sides with respect to the second support block at the bottom of the body frame and configured to include upper portions formed to have a curved shape to support the bottom of the fuel tank.

The fuel tank accommodating part may include: a fixing bar configured to be disposed on a top of the body frame and to have a curved shape to fix a top of the fuel tank; and a fixing pin configured to fasten and fix the fixing bar to the top of the body frame.

The stack accommodating part may include: stack brackets disposed at both sides of the body frame to accommodate the stack of fuel cells; a stack fixing beam configured to be coupled to the stack bracket in a plurality of stages and fix the stack of fuel cells; and a discharge port configured to be connected to a bottom of the stack bracket to discharge water which is discharged from the stack to an outside.

The open type module structure of the fuel cell power pack may further include a plurality of air holes configured to be formed at the bottom of the front portion of the body frame so that the air flows toward a bottom of the control panel.

The valve detachable part may include: a valve coupling pipe disposed on the front portion of the body frame and configured to be connected to the manifold part; and a valve guide pipe configured to be connected to the valve coupling pipe, the regulator valve of the fuel tank being inserted into the valve guide pipe.

The valve detachable part may further include a detachable bar configured to fasten a flange of the valve guide pipe and a flange of the valve coupling pipe.

The manifold part may include: a manifold block disposed on the front portion of the body frame; a pressing groove formed in the manifold block; a central hole formed along a circumference of the pressing groove in the manifold block; a manifold passage connected to the central hole and configured to be branched in plural; and a connecting pipe configured to connect the manifold passage with the stack of fuel cells.

The manifold part may include: a branch hole formed between the central hole and the manifold passage; and a check valve disposed in the manifold block to drive an opening and closing bar for opening and closing the branch hole.

The open type module structure of the fuel cell power pack may further include a battery accommodating part disposed at one side of the front portion of the body frame to accommodate a battery for supplying power in parallel with the fuel cell.

The open type module structure of the fuel cell power pack may further include a fan accommodating part disposed to be connected to the stack accommodating part at both ends of the body frame so that air is introduced into the stack accommodating part, and the fan accommodating part may include: a duct connected to the stack bracket, the air passing through the stack being collected in the duct; and a fan disposed inside a fan block connected to the duct to discharge the air which is collected in the duct to the outside.

The open type module structure of the fuel cell power pack may further include a drainage part disposed at the bottom of the body frame to discharge fluid, and the drainage part may include: a drainage tank formed to have a recessed shape at the bottom of the body frame, the fluid being collected in the drainage tank; and a drainage hole formed in the drainage tank to discharge the fluid to an outside.

The drainage part may further include a stepped part formed to have a height difference at the bottom of the body frame so that the fluid flows to the drainage tank at the bottom of the body frame.

According to an aspect of another exemplary embodiment, there is provided a fuel cell power pack for a drone including: a body frame configured to include an incised portion; a fuel tank accommodating part disposed in a center of the body frame to accommodate a fuel tank; stack accommodating parts disposed at both sides of the body frame to accommodate a stack of fuel cells; a control panel disposed at a bottom of the body frame to perform operations related to the fuel cell power pack; a valve detachable part disposed at a front of the body frame and configured to be connected to a regulator valve of the fuel tank; a manifold part disposed in the body frame to connect the valve detachable part with the stack of fuel cells; a drainage part disposed at the bottom of the body frame to discharge fluid; a battery accommodating part disposed in the body frame to accommodate a battery for supplying power in parallel with the fuel cell; and a fan accommodating part disposed to be connected to the stack accommodating part at both ends of the body frame so that air is introduced into the stack accommodating part, wherein the fuel cell power pack configures a module structure in an open type.

The fuel tank accommodating part may include a first support block disposed on a rear portion of the body frame and configured to include an upper portion formed to have a curved shape to support a bottom of the fuel tank, a second support block disposed on a bottom of the body frame and configured to include an upper portion formed to have a curved shape to support the bottom of the fuel tank, a plurality of auxiliary beams disposed at both sides with respect to the second support block at the bottom of the body frame and configured to include upper portions formed to have a curved shape to support the bottom of the fuel tank, a fixing bar configured to be disposed on a top of the body frame and to have a curved shape to fix a top of the fuel tank, and a fixing pin configured to fix the fixing bar to the top of the body frame.

The stack accommodating part may include stack brackets disposed at both sides of the body frame to accommodate the stack of fuel cells, a stack fixing beam configured to be coupled to the stack bracket in a plurality of stages and fix the stack of fuel cells, and a discharge port configured to be connected to a bottom of the stack bracket to discharge water which is discharged from the stack to an outside.

The valve detachable part may include a valve coupling pipe disposed on the front of the body frame and configured to be connected to the manifold part, a valve guide pipe configured to be connected to the valve coupling pipe, the regulator valve of the fuel tank being inserted into the valve guide pipe, and a detachable bar configured to fasten a flange of the valve guide pipe and a flange of the valve coupling pipe.

The manifold part may include a manifold block disposed on the front of the body frame, a pressing groove formed in the manifold block, a central hole formed along a circumference of the pressing groove in the manifold block, a manifold passage connected to the central hole and configured to be branched in plural, a connecting pipe configured to connect the manifold passage with the stack of fuel cells, a branch hole formed between the central hole and the manifold passage, and a check valve disposed in the manifold block to drive an opening and closing bar for opening and closing the branch hole.

The drainage part may include a drainage tank formed to have a recessed shape at the bottom of the body frame, the fluid being collected in the drainage tank, a drainage hole formed in the drainage tank to discharge the fluid to an outside, and a stepped part formed to have a height difference at the bottom of the body frame so that the fluid flows to the drainage tank at the bottom of the body frame.

The present disclosure provides the power pack driven by the fuel cell, and has the superior output relative to the weight as compared to the general battery applied to the flying object such as the drone in the market, thereby enabling the long-time operation of the drone.

Further, the present disclosure configures the module structure of the fuel cell power pack in an open type, thereby achieving the lighter weight than a close type housing structure which is conventionally a general form. This may reduce the overall weight of the drone when the fuel cell power pack is mounted thereto, thereby improving the flight time, the payload value, and the like of the drone. Further, by removing a handle of the fuel tank containing hydrogen gas to reduce the weight of the fuel tank itself, it is also possible to achieve the same effect.

Further, because the present disclosure has the open type module structure, replacement or maintenance of components or batteries may be easily performed by a good internal visibility. This may allow components of the fuel cell power pack to be naturally air-cooled during the operation of the drone, thereby improving the overall cooling efficiency.

In addition, the present disclosure uses hydrogen as fuel for the fuel cell power pack, and even if hydrogen leaks due to issues such as aging and unexpected accidents in use, hydrogen is immediately diffused to an atmosphere because the fuel cell power pack is not the close type module structure but the open type module structure, such that hydrogen may not be accumulated inside the fuel cell power pack, thereby preventing a safety accident problem such as explosion, and being advantageous in terms of safety.

Further, the present disclosure may dispose the fuel tank at a central side of the module, and dispose a plurality of stacks at positions, which are symmetrical to both sides of the fuel tank from an inside of the module, so as to balance the weight, thereby achieving a stable operation of the drone when the module is mounted to the drone.

Further, the present disclosure mounts a manual valve which controls the opening and closing of the manifold part, thereby minimizing the reduction in the reliability, the increase in the cost, and the increase in weight which are caused by mounting an automatic control valve. A user may arbitrarily adjust the hydrogen supply timing through the manual valve control, and it is possible to prevent hydrogen from being supplied at the undesired timing due to the control error when the automatic control valve is mounted. In the event of an emergency, the user may block the hydrogen supply directly and physically, thereby improving a control error and safety issues.

In addition, the use of the manual valve may reduce the overall weight of the drone, thereby extending the flight time of the drone and improving the payload value, and the cost may be reduced, thereby reducing the production cost of the fuel cell power pack.

Further, the present disclosure may also mount an electronically controlled flow rate control valve, such as a solenoid valve, to the manifold part, thereby controlling the flow rate of the hydrogen gas supplied to the stack. This enables the user to turn on/off the fuel cell at a desired timing, and to stop the operation of the fuel cell in an event of an emergency.

Further, the present disclosure has a structure in which the regulator valve is opened and closed and the gas passage is communicated with a simple operation in which the user attaches and detaches the regulator valve connected to the fuel tank to and from the manifold part, thereby improving work convenience.

Further, the present disclosure is configured so that the discharge water and the condensate, generated from the air discharge, the hydrogen purge, the regulator valve, the hydrogen container, and the like, may be collected at and discharged from one point through the recessed discharge structure at the part of the bottom of the module, due to the characteristics of the fuel cell. This is developed so that the inside of the module may be kept clean, the control device such as a circuit board may be blocked from being exposed to rainwater, condensate, or the like, and the drone may be prevented from being malfunctioned due to a moisture introduced into the drone which is mainly mounted at the bottom of the fuel cell power pack. Because the present disclosure has the open type module structure, the control device, the harness, the connector, and the like may be insulated or waterproofed.

Further, the present disclosure disposes the battery such as the lithium ion battery and controls the power to be supplied in parallel with the fuel cell, thereby enabling stable power supply to the drone.

Further, the present disclosure disposes the control panel at the bottom of the front portion of the module, and disposes a plurality of air holes adjacent to the control panel, so that the control panel is configured to be air-cooled by the air during the flight of the drone, thereby enhancing cooling efficiency.

Further, the present disclosure configures the duct which is connected by closing one surface of the stack, and disposes the fan on the duct, so that the air is introduced into the other surface of the stack when the fan exhausts the air, thereby smoothly introducing the air into the stack.

### BRIEF DESCRIPTION OF THE DRAWINGS

The above and other aspects will become more apparent from the following description of the exemplary embodiments with reference to the accompanying drawings, in which:

FIG. 1 is a perspective diagram illustrating one side of an open type module structure of a fuel cell power pack according to an exemplary embodiment;

FIG. 2 is a perspective diagram illustrating the other side of the open type module structure of the fuel cell power pack according to an exemplary embodiment;

FIG. 3 is a plan diagram illustrating the open type module structure of the fuel cell power pack according to an exemplary embodiment;

FIG. 4 is a bottom diagram illustrating the open type module structure of the fuel cell power pack according to an exemplary embodiment;

FIG. 5 is a rear diagram illustrating the open type module structure of the fuel cell power pack according to an exemplary embodiment;

FIG. 6 is a front diagram illustrating the open type module structure of the fuel cell power pack according to an exemplary embodiment;

FIG. 7 is a side diagram illustrating the open type module structure of the fuel cell power pack according to an exemplary embodiment;

FIG. 8 is a perspective diagram illustrating a state in which a fuel tank is mounted to the open type module structure of the fuel cell power pack according to an exemplary embodiment;

FIG. 9 is a plan diagram illustrating a state in which the fuel tank is mounted to the open type module structure of the fuel cell power pack according to an exemplary embodiment;

FIG. 10 is a diagram illustrating opening and closing structures of a manifold part and a regulator valve according to an exemplary embodiment; and

FIG. 11 is a diagram illustrating structures of a check valve and a branch hole of the manifold part according to an exemplary embodiment.

### DETAILED DESCRIPTION

Various modifications may be made to the embodiments of the disclosure, and there may be various types of embodiments. Thus, specific embodiments will be illustrated in the accompanying drawings and the embodiments will be described in detail in the description. However, it should be noted that the various embodiments are not for limiting the scope of the disclosure to a specific embodiment, but they should be interpreted to include all modifications, equivalents or alternatives of the embodiments included in the ideas and the technical scopes disclosed herein.

Meanwhile, in case it is determined that in describing the embodiments, detailed explanation of related known technologies may unnecessarily confuse the gist of the disclosure, the detailed explanation will be omitted.

The terminology used herein is for the purpose of describing particular embodiments only and is not intended to limit the scope of the disclosure. As used herein, the singular forms “a”, “an”, and “the” are intended to include the plural forms as well, unless the context clearly indicates otherwise. In this specification, terms such as “comprise”, “include”, or “have/has” should be construed as designating that there are such features, integers, steps, operations, elements, components, and/or a combination thereof in the specification, not to exclude the presence or possibility of adding one or more of other features, integers, steps, operations, elements, components, and/or combinations thereof

Further, terms such as “first,” “second,” and so on may be used to describe a variety of elements, but the elements should not be limited by these terms. The terms are used simply to distinguish one element from other elements. The use of such ordinal numbers should not be construed as limiting the meaning of the term. For example, the components associated with such an ordinal number should not be limited in the order of use, placement order, or the like. If necessary, each ordinal number may be used interchangeably.

Hereinafter, an open type module structure of a fuel cell power pack according to exemplary embodiments will be described in detail with reference to the accompanying drawings. In order to clearly illustrate the disclosure in the drawings, some of the elements that are not essential to the complete understanding of the disclosure may be omitted, and like reference numerals refer to like elements throughout the specification.

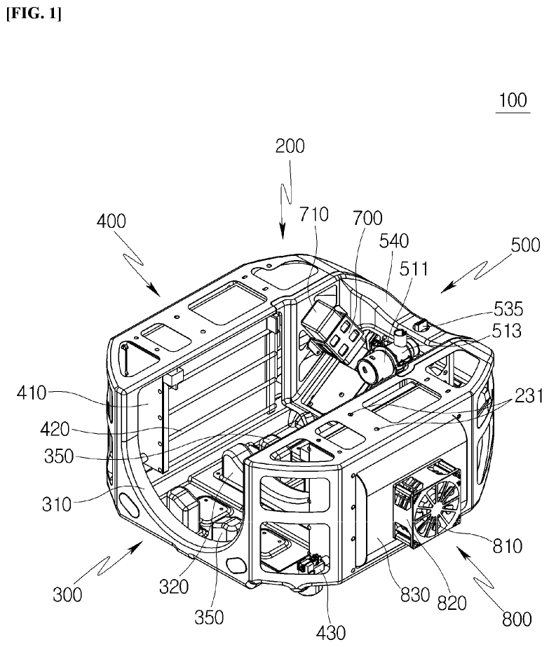

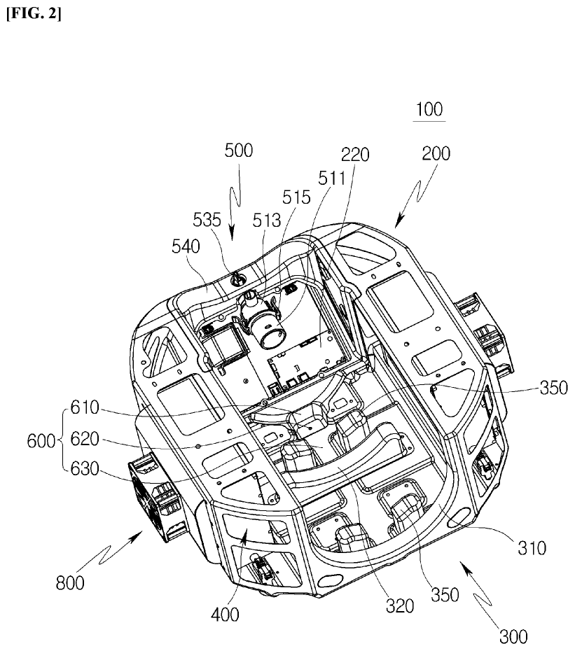

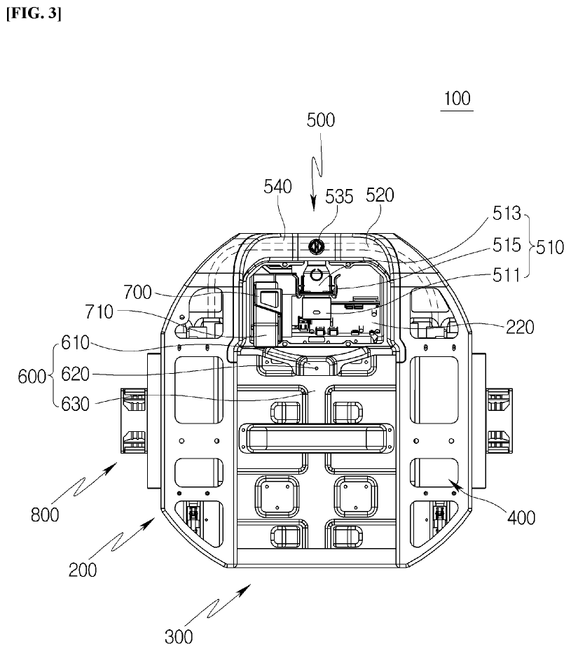

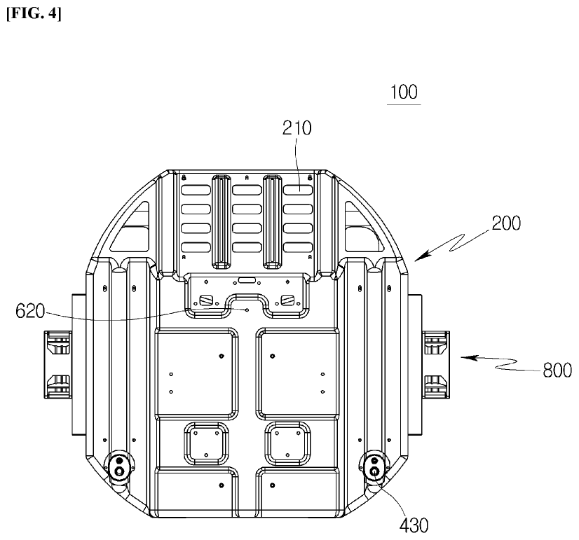

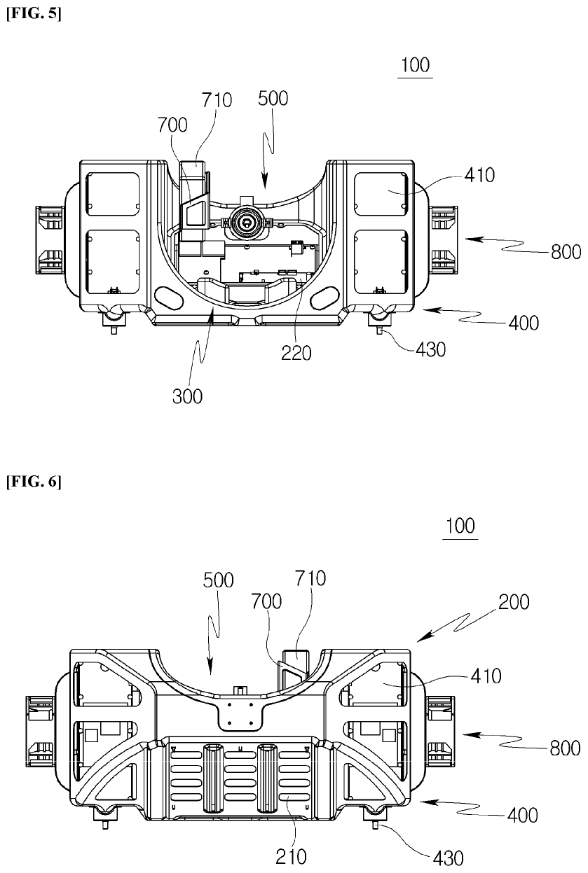

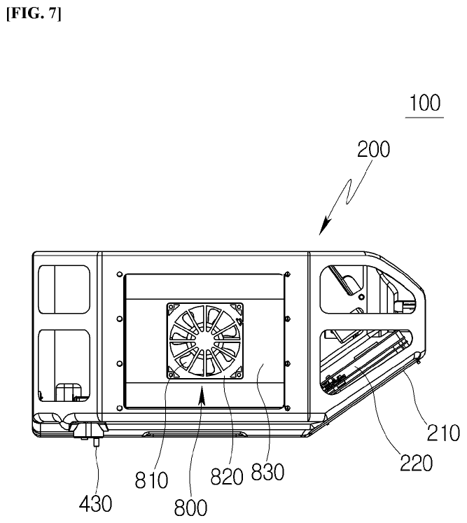

FIG. 1 is a perspective diagram illustrating one side of an open type module structure 100 of a fuel cell power pack according to an exemplary embodiment, FIG. 2 is a perspective diagram illustrating the other side of the open type module structure 100 of the fuel cell power pack according to an exemplary embodiment, FIG. 3 is a plan diagram illustrating the open type module structure 100 of the fuel cell power pack according to an exemplary embodiment, FIG. 4 is a bottom diagram illustrating the open type module structure 100 of the fuel cell power pack according to an exemplary embodiment, FIG. 5 is a rear diagram illustrating the open type module structure 100 of the fuel cell power pack according to an exemplary embodiment, FIG. 6 is a front diagram illustrating the open type module structure 100 of the fuel cell power pack according to an exemplary embodiment, and FIG. 7 is a side diagram illustrating the open type module structure 100 of the fuel cell power pack according to the present disclosure.

Referring to FIGS. 1 to 7, the open type module structure 100 of the fuel cell power pack according to an exemplary embodiment may include a body frame 200, a fuel tank accommodating part 300, a stack accommodating part 400, a control panel 220, a manifold part 500, a valve detachable part 510, a drainage part 600, a battery accommodating part 700, and a fan accommodating part 800.

The body frame 200 may form an entire skeleton, and have an incised portion to reduce a weight. The body frame 200 may be made of a metal material including titanium and aluminum or a reinforced plastic material.

The drainage part 600 which is disposed at a bottom of the body frame 200 may discharge fluid such as rainwater and condensate. The drainage part 600 may include a drainage tank 610, a drainage hole 620, and a stepped part 630.

The drainage tank 610 may be a portion which is formed to have a recessed shape at the bottom of the body frame 200, and in which fluid accumulated in the bottom of the body frame 200 is collected. The drainage hole 620 formed in the drainage tank 610 discharges the fluid to an outside.

The stepped part 630 may be formed to have a height difference so that the fluid flows to the drainage tank 610 at the bottom of the body frame 200.

For example, the fluid such as rainwater, condensate, or the like may be collected in the bottom of the body frame 200 during an operation of a drone, and the fluid is collected into the drainage tank 610 after moving downward to the stepped part 630 and is discharged to the outside through the drainage hole 620. Accordingly, an inside of the body frame 200 may be kept clean and a malfunction of the device may be minimized.

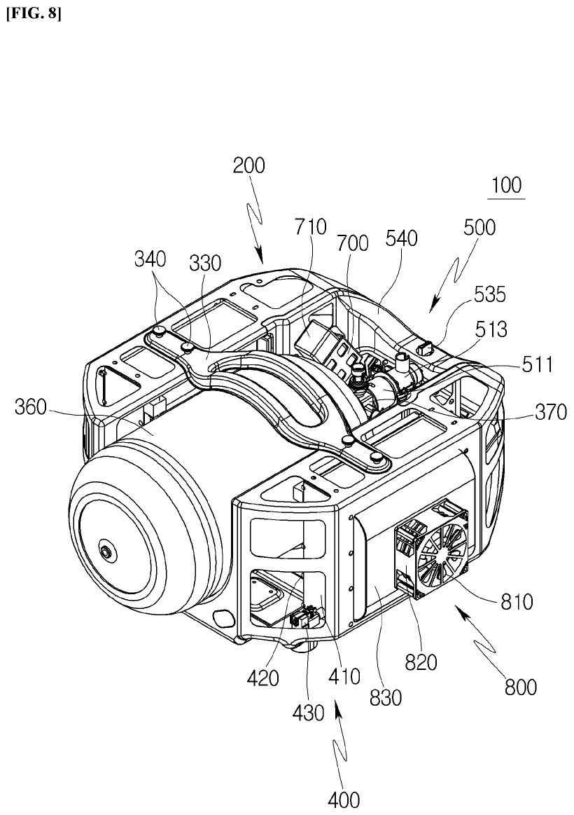

FIG. 8 is a perspective diagram illustrating a state in which a fuel tank is mounted to the open type module structure of the fuel cell power pack according to an exemplary embodiment. Referring to FIGS. 1 to 8, the fuel tank accommodating part 300 which is disposed at a central portion of the body frame 200 accommodates a fuel tank 360. The fuel tank accommodating part 300 may include a first support block 310, a second support block 320, an auxiliary beam 350, a fixing bar 330, and a fixing pin 340.

The first support block 310 which is disposed on a rear portion of the body frame 200 may include an upper portion formed to have a curved shape to support a bottom of the fuel tank 360. The second support block 320 which is disposed at the bottom of the body frame 200 may include an upper portion formed to have a curved shape to support the bottom of the fuel tank 360.

Here, a plurality of auxiliary beams 350 which are disposed at both sides with respect to the second support block 320 at the bottom of the body frame 200 may include an upper portion formed to have a curved shape to support the bottom of the fuel tank 360. For example, four auxiliary beams 350 may be disposed in pairs at both sides of the second support block 320.

The fuel tank 360 is supported by the first and second support blocks 310, 320 and the auxiliary beam 350, and is seated stably on the central portion of the body frame 200.

For example, after disposing the fuel tank 360 in the fuel tank accommodating part 300, in order to fix a top of the fuel tank 360, the fixing bar 330 may be fixed by seating the fixing bar 330 at a top of the body frame 200 and fastening the fixing pin 340 to a fixing hole 231 formed at the top of the body frame 200. That is, the fixing bar 330 may be fixed to the top of the body frame 200 by the fixing pin 340 while pressing the top of the fuel tank 360, such that the fuel tank 360 may be stably fixed and disposed at the central portion of the body frame 200.

The stack accommodating part 400 which is disposed at both sides of the body frame 200 accommodates a stack of fuel cells. The stack accommodating part 400 may include a stack bracket 410, a stack fixing beam 420, and a discharge port 430.

The stack bracket 410 may be portions which are disposed at both sides of the body frame 200, and in which the stack of the fuel cells is accommodated. The stack bracket 410 is configured in the form of a rectangular paralleletubed in the present disclosure, but it is understood that this is only an example and other exemplary embodiments are not limited thereto.

The stack fixing beam 420 may be coupled to the stack bracket 410 in a plurality of stages and fix the stack inserted into the stack bracket 410. If a user replaces or maintains the stack, the user may conveniently perform the work by removing only the stack fixing beam 420 from holes formed in the plurality of stages in the stack bracket 410.

The discharge port 430 may be connected to a bottom of the stack bracket 410, and discharge a water which is discharged from the stack to the outside. Because the water generated after an electrochemical reaction in the stack usually flows downward by gravity, the discharge port 430 is connected to and disposed at the bottom of the stack bracket 410.

The fan accommodating part 800 may be connected to the stack accommodating part 400 at both ends of the body frame 200 so that air is forcibly introduced into the stack accommodating part 400. The fan accommodating part 800 may include a duct 830, a fan block 820, and a fan 810.

The duct 830 may be a portion which is connected to the stack bracket 410, and in which the air passing through the stack is collected. The fan block 820 is connected to the duct 830, and the fan 810 may be disposed inside the fan block 820.

The fan 810 may discharge the air collected in the duct 830 to the outside.

Here, the fan 810 discharges an internal air of the stack to the outside upon an initial operation so that an external air is forcibly introduced into the stack. That is, by removing the internal air of the stack, the fan 810 creates an interior of the stack in a low pressure or negative pressure state which is lower than an atmospheric pressure. Accordingly, the air is naturally introduced into the stack through one surface of the stack, which is disposed at an opposite side of the duct 830, by the air pressure difference. Also, the air may be forcibly introduced to increase a reactivity of the stack.

The control panel 220 may be disposed at a bottom of a front portion of the body frame 200. The control panel 220 may perform various electronic/mechanical operations, related to the fuel cell power pack, for the fan 810, a battery 710, and a check valve 535, or a function of a wireless controller.

Because the body frame 200 has an open structure, an upper portion of the control panel 220 may be cooled by an air flow generated during the operation of the drone. However, because a lower portion of the control panel 220 is covered by the front portion of the body frame 200, the air may not be smoothly introduced, thereby degrading air-cooling efficiency.

To this end, a plurality of air holes 210 may be disposed at the bottom of the front portion of the body frame 200. Because the plurality of air holes 210 are disposed to face the lower portion of the control panel 220, the air is introduced into the body frame 200 through the air holes 210 during the operation of the drone and cools the lower portion of the control panel 220.

Through the above described structure, it is possible to effectively air-cool both the upper portion and the lower portion of the control panel 220.

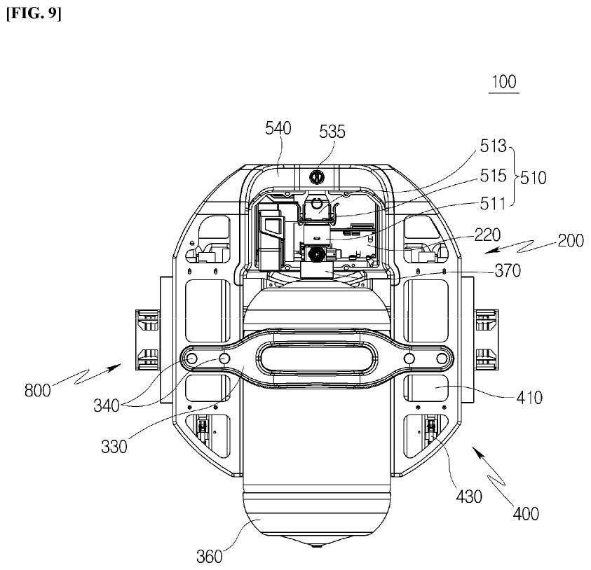

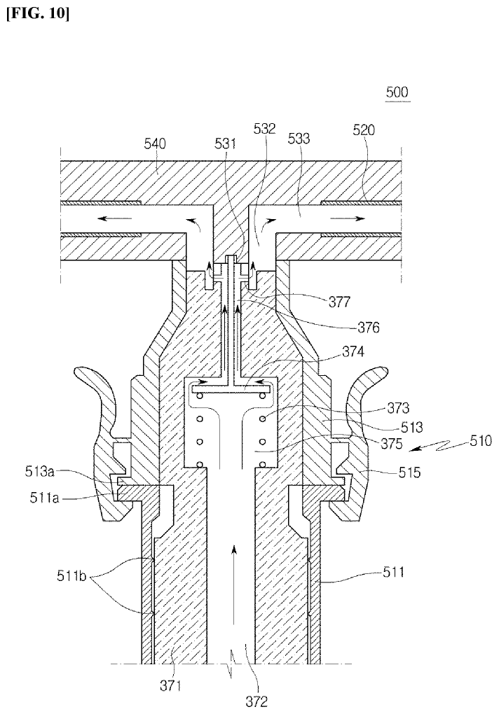

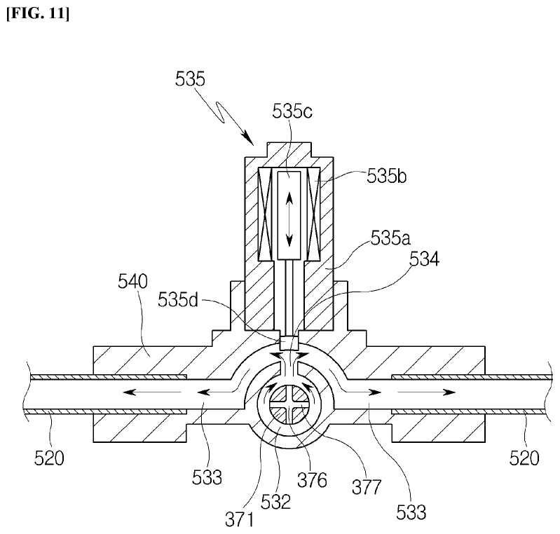

FIG. 9 is a plan diagram illustrating a state in which the fuel tank 360 is mounted to the open type module structure 100 of the fuel cell power pack according to an exemplary embodiment, FIG. 10 is a diagram illustrating opening and closing structures of a manifold part 500 and a regulator valve 370 according to an exemplary embodiment, and FIG. 11 is a diagram illustrating structures of a check valve 535 and a branch hole 534 of the manifold part 500 according to an exemplary embodiment.

Referring to FIGS. 1 to 11, the valve detachable part 510 which is disposed on the front portion of the body frame 200 is connected to a regulator valve 370 of the fuel tank 360. The valve detachable part 510 may include a valve guide pipe 511, a valve coupling pipe 513, and a detachable bar 515.

The valve coupling pipe 513 which is disposed on the front portion of the body frame 200 is connected to the manifold part 500. The valve guide pipe 511 may be a portion which is connected to the valve coupling pipe 513, and into which the regulator valve 370 of the fuel tank 360 is inserted. A protrusion 511b which supports an outer circumference of the regulator valve 370 of the fuel tank 360 may be disposed inside the valve guide pipe 511.

The detachable bar 515 may be configured so that a flange 511a of the valve guide pipe 511 and a flange 513a of the valve coupling pipe 513 are fastened to each other. If the user grabs the detachable bars 515 disposed in pairs at both sides of the valve coupling pipe 513, and narrows the detachable bar 515 inward, the flange 511a of the valve guide pipe 511 and the flange 513a of the valve coupling pipe 513 are separated from each other. On the contrary, if the user grabs the detachable bars 515 and widens the detachable bar 515 outward, the flange 511a of the valve guide pipe 511 and the flange 513a of the valve coupling pipe 513 are fixed.

The manifold part 500 which is disposed on the front portion of the body frame 200 may connect the valve detachable part 510 with the stack. Referring to FIGS. 3, 10, and 11, the manifold part 500 may include a manifold block 540, a pressing groove 531, a central hole 532, a manifold passage 533, a connecting pipe 520, a branch hole 534, and a check valve 535.

For example, the regulator valve 370 of the fuel tank 360 may include a valve body 371 which is inserted into the valve guide pipe 511 and the valve coupling pipe 513, an inner passage 372 through which hydrogen gas flows and which is formed inside the valve body 371 and is connected to an opening and closing space 375. The regulator valve 370 of the fuel tank 360 may further include an opening and closing spring 373 which is disposed in the opening and closing space 375 and is in contact with an opening and closing bar 374 to apply an elastic force to the opening and closing bar 374, thereby closing a through hole 376 through the opening and closing bar 374.

If the opening and closing bar 374 is inserted into the pressing groove 531 and pressed, the opening and closing bar 374 is opened, and hydrogen gas passes through the through hole 376 and flows to the manifold passage 533 through a distribution passage 377.

The manifold block 540 which is disposed on the front portion of the body frame 200 may include the pressing groove 531. The distribution passage 377 is opened and hydrogen gas is introduced, while the opening and closing bar 374 is inserted into the pressing groove 531 and pressed.

The central hole 532 is formed along a circumference of the pressing groove 531 in the manifold block 540. The central hole 532 is a portion in which the hydrogen gas discharged from the distribution passage 377 is collected.

Further, the manifold passage 533 is connected to the central hole 532 to induce hydrogen gas to the connecting pipe 520. The connecting pipe 520 connects the manifold passage 533 with the stack and the hydrogen gas is supplied to the stack through the connecting pipe 520.

Referring to FIG. 11, in order to control the flow of the hydrogen gas, the branch hole 534 is formed between the central hole 532 and the manifold passage 533, and the check valve 535 which opens and closes the branch hole 534 may be disposed in the manifold block 540.

The check valve 535 may include a housing 535a, a stator 535b, a rotor 535c, and an opening and closing piece 535d. The housing 535a may be connected to the manifold block 540, the stator 535b may be disposed inside the housing 535a, and the rotor 535c may be disposed at a central side of the stator 535b. Further, the opening and closing piece 535d may be mounted to an end of the rotor 535c.

In one or more exemplary embodiments, the check valve 535 may be a normal close type valve, which is in a closed state at all times. In this case, if the user applies power, the check valve 535 is opened.

That is, in a state in which the opening and closing piece 535d is inserted into the branch hole 534, if the user applies power, the rotor 535c moves in an opposite direction of the branch hole 534 by an electromagnetic reaction. Accordingly, the opening and closing piece 535d mounted to the end of the rotor 535c is separated from the branch hole 534 and adjusts the opening and closing of the branch hole 534.

If the user turns off the power to stop using the fuel cell power pack, the rotor 535c moves back toward the branch hole 534, and the opening and closing piece 535d is inserted into the branch hole 534 to block the flow of the hydrogen gas.

For example, the check valve 535 may be closed automatically if a failure of the fuel cell power pack or a dangerous situation occurs.

Here, the check valve 535 serves as an auxiliary device which controls the flow of the hydrogen gas together with the opening and closing bar 374.

For example, if the opening and closing bar 374 is damaged or worn out due to external impact or long-time use and thus the hydrogen gas is not smoothly supplied, the check valve 535 may auxiliarily control the supply of the gas through an operation of opening and closing the branch hole 534.

Because the hydrogen gas used in the exemplary embodiment is a flammable material, the supply of the hydrogen gas may be controlled more stably through a primary opening and closing structure by the opening and closing bar 374 and the pressing groove 531 and a secondary opening and closing structure by the check valve 535 and the branch hole 534.

Alternatively, the check valve 535 may be a manual valve. In a case of the manual valve, the user may directly open and close the branch hole 534 by moving the opening and closing piece 535d through an operation of the valve.

In a case of an electronically controlled and operated check valve, a control error may occur. If the control error occurs, hydrogen gas may be supplied at a timing not desired by the user, and a safety accident such as an explosion may occur if the supply of the hydrogen gas is not blocked in the event of an emergency.

However, if the manual valve is mounted, the user may arbitrarily adjust the timing for supplying hydrogen gas, and in the event of an emergency, the user may control the supply of the hydrogen gas directly and physically, thereby improving reliability and safety issues related to the control error.

In addition, because the automatic control valve has an electronic control component disposed therein, a weight and cost thereof increase, and the use of the manual valve may improve such a problem. That is, the total weight of the drone may be reduced, thereby extending the flight time of the drone, improving the payload value, and reducing the cost to reduce the production cost of the fuel cell power pack.

Referring to FIGS. 1 and 3, the battery accommodating part 700 may be disposed in a form of a bracket at one side of the front portion of the body frame 200 to accommodate a battery 710 which supplies power in parallel with the fuel cell. The battery 710 may be a lithium battery or the like, but is not limited thereto.

That is, the fuel cell and the battery 710 are connected in circuit in parallel with each other at the control panel 220, and accordingly, may selectively supply power to the drone.

For example, in the stack configuring the fuel cell, power generated in the electrochemical reaction process of oxygen and hydrogen is supplied to the drone and operates the drone.

If an output higher than an output amount generated by the stack of the fuel cell is required according to the flight and mission performance environment of the drone, the battery 710 in parallel with the fuel cell supplies an insufficient output.

In another situation, for example, if an accidental situation occurs in which the stack is broken and power generation is stopped, the battery 710 may supply emergency power to prevent the drone from being stopped during flight.

Further, a plurality of battery accommodating parts 700 may be disposed in pairs at both sides of the front portion of the body frame 200 to balance the weight and prevent an operation of a flying object from being hindered.

While exemplary embodiments have been described with reference to the accompanying drawings, it is to be understood by those skilled in the art that various modifications in form and details may be made therein without departing from the sprit and scope as defined by the appended claims. Therefore, the description of the exemplary embodiments should be construed in a descriptive sense and not to limit the scope of the claims, and many alternatives, modifications, and variations will be apparent to those skilled in the art.

What is claimed is:

1. An open type module structure of a fuel cell power pack comprising:
a body frame;
a fuel tank accommodating part disposed on a central portion of the body frame to accommodate a fuel tank;
stack accommodating parts disposed at both sides of the body frame to accommodate a stack of fuel cells;
a control panel disposed at a bottom of a front portion of the body frame;
a valve detachable part disposed on the front portion of the body frame and configured to be connected to a regulator valve of the fuel tank; and
a manifold part disposed on the front portion of the body frame to connect the valve detachable part with the stack of fuel cells.

2. The open type module structure of claim 1,
wherein the fuel tank accommodating part comprises:
a first support block disposed on a rear portion of the body frame and configured to include an upper portion formed to have a curved shape to support a bottom of the fuel tank; and
a second support block disposed on a bottom of the body frame and configured to include an upper portion formed to have a curved shape to support the bottom of the fuel tank.

3. The open type module structure of claim 2, further comprising a plurality of auxiliary beams disposed at both sides with respect to the second support block at the bottom of the body frame and configured to include upper portions formed to have a curved shape to support the bottom of the fuel tank.

4. The open type module structure of claim 2,
wherein the fuel tank accommodating part comprises:
a fixing bar configured to be disposed on a top of the body frame and to have a curved shape to fix a top of the fuel tank; and
a fixing pin configured to fasten and fix the fixing bar to the top of the body frame.

5. The open type module structure of claim 1,
wherein the stack accommodating part comprises:
stack brackets disposed at both sides of the body frame to accommodate the stack of fuel cells;
a stack fixing beam configured to be coupled to the stack bracket in a plurality of stages and fix the stack of fuel cells; and
a discharge port configured to be connected to a bottom of the stack bracket to discharge water which is discharged from the stack to an outside.

6. The open type module structure of claim 1, further comprising a plurality of air holes configured to be formed at the bottom of the front portion of the body frame so that the air flows toward a bottom of the control panel.

7. The open type module structure of claim 1,
wherein the valve detachable part comprises:
a valve coupling pipe disposed on the front portion of the body frame and configured to be connected to the manifold part; and
a valve guide pipe configured to be connected to the valve coupling pipe, the regulator valve of the fuel tank being inserted into the valve guide pipe.

8. The open type module structure of claim 7,
wherein the valve detachable part further comprises a detachable bar configured to fasten a flange of the valve guide pipe and a flange of the valve coupling pipe.

9. The open type module structure of claim 7,
wherein the manifold part comprises:
a manifold block disposed on the front portion of the body frame;
a pressing groove formed in the manifold block;
a central hole formed along a circumference of the pressing groove in the manifold block;
a manifold passage connected to the central hole and configured to be branched in plural; and
a connecting pipe configured to connect the manifold passage with the stack of fuel cells.

10. The open type module structure of claim 9,
wherein the manifold part comprises:
a branch hole formed between the central hole and the manifold passage; and
a check valve disposed in the manifold block to drive an opening and closing bar for opening and closing the branch hole.

11. The open type module structure of claim 1, further comprising a battery accommodating part disposed at one side of the front portion of the body frame to accommodate a battery for supplying power in parallel with the fuel cell.

12. The open type module structure of claim 5, further comprising a fan accommodating part disposed to be connected to the stack accommodating part at both ends of the body frame so that air is introduced into the stack accommodating part,
wherein the fan accommodating part comprises:
a duct connected to the stack bracket, the air passing through the stack being collected in the duct; and
a fan disposed inside a fan block connected to the duct to discharge the air which is collected in the duct to the outside.

13. The open type module structure of claim 1, further comprising a drainage part disposed at the bottom of the body frame to discharge fluid,
wherein the drainage part comprises:
a drainage tank formed to have a recessed shape at the bottom of the body frame, the fluid being collected in the drainage tank; and
a drainage hole formed in the drainage tank to discharge the fluid to an outside.

14. The open type module structure of claim 13,
wherein the drainage part further comprises a stepped part formed to have a height difference at the bottom of the body frame so that the fluid flows to the drainage tank at the bottom of the body frame.

15. A fuel cell power pack for a drone comprising:
a body frame configured to include an incised portion;
a fuel tank accommodating part disposed in a center of the body frame to accommodate a fuel tank;
stack accommodating parts disposed at both sides of the body frame to accommodate a stack of fuel cells;
a control panel disposed at a bottom of the body frame to perform operations related to the fuel cell power pack;
a valve detachable part disposed at a front of the body frame and configured to be connected to a regulator valve of the fuel tank;
a manifold part disposed in the body frame to connect the valve detachable part with the stack of fuel cells;
a drainage part disposed at the bottom of the body frame to discharge fluid;
a battery accommodating part disposed in the body frame to accommodate a battery for supplying power in parallel with the fuel cell; and
a fan accommodating part disposed to be connected to the stack accommodating part at both ends of the body frame so that air is introduced into the stack accommodating part,
wherein the fuel cell power pack configures a module structure in an open type.

16. The fuel cell power pack of claim 15,
wherein the fuel tank accommodating part comprises:
a first support block disposed on a rear portion of the body frame and configured to include an upper portion formed to have a curved shape to support a bottom of the fuel tank;
a second support block disposed on a bottom of the body frame and configured to include an upper portion formed to have a curved shape to support the bottom of the fuel tank;
a plurality of auxiliary beams disposed at both sides with respect to the second support block at the bottom of the body frame and configured to include upper portions formed to have a curved shape to support the bottom of the fuel tank;
a fixing bar configured to be disposed on a top of the body frame and to have a curved shape to fix a top of the fuel tank; and
a fixing pin configured to fix the fixing bar to the top of the body frame.

17. The fuel cell power pack of claim 15,
wherein the stack accommodating part comprises:
stack brackets disposed at both sides of the body frame to accommodate the stack of fuel cells;
a stack fixing beam configured to be coupled to the stack bracket in a plurality of stages and fix the stack of fuel cells; and
a discharge port configured to be connected to a bottom of the stack bracket to discharge water which is discharged from the stack to an outside.

18. The fuel cell power pack of claim 15,
wherein the valve detachable part comprises:
a valve coupling pipe disposed on the front of the body frame and configured to be connected to the manifold part;
a valve guide pipe configured to be connected to the valve coupling pipe, the regulator valve of the fuel tank being inserted into the valve guide pipe; and
a detachable bar configured to fasten a flange of the valve guide pipe and a flange of the valve coupling pipe.

19. The fuel cell power pack of claim 18,
wherein the manifold part comprises:
a manifold block disposed on the front of the body frame;
a pressing groove formed in the manifold block;
a central hole formed along a circumference of the pressing groove in the manifold block;
a manifold passage connected to the central hole and configured to be branched in plural;
a connecting pipe configured to connect the manifold passage with the stack of fuel cells;
a branch hole formed between the central hole and the manifold passage; and
a check valve disposed in the manifold block to drive an opening and closing bar for opening and closing the branch hole.

20. The fuel cell power pack of claim 15,
wherein the drainage part comprises:
a drainage tank formed to have a recessed shape at the bottom of the body frame, the fluid being collected in the drainage tank;
a drainage hole formed in the drainage tank to discharge the fluid to an outside; and
a stepped part formed to have a height difference at the bottom of the body frame so that the fluid flows to the drainage tank at the bottom of the body frame.
